(19) United States
(12) Patent Application Publication
(10) Pub. No.: US 2011/0254831 A1
(43) Pub. Date: Oct. 20, 2011

(54) SCAN DRIVE CONTROL SYSTEM AND METHOD FOR LIQUID CRYSTAL PANEL AND COMPUTER PROGRAM PRODUCT THEREOF

(75) Inventors: Yuan-Hao Chang, Taipei City (TW); Kuang-Kuei Wang, Taoyuan City (TW)

(73) Assignee: CHUNGHWA PICTURE TUBES, LTD., Padeh City (TW)

(21) Appl. No.: 12/859,006

(22) Filed: Aug. 18, 2010

(30) Foreign Application Priority Data
Apr. 16, 2010 (TW) 099111981

(51) Int. Cl. G09G 3/36; G09G 5/00

(52) U.S. Cl. 345/214; 345/99

(57) ABSTRACT

A scan drive control system and method for a liquid crystal panel and a computer program product thereof are provided for controlling a plurality of gate scan lines. The system includes a time controller, a gate integrated circuit (IC), and selection modules. The time controller generates a scan signal periodically and the scan signal is acquired by the gate IC. The gate IC outputs the scan signals according to a sequence of master scan control lines, and outputs an enable signal corresponding to the scan signal and an occurred period of the scan signal according to an enable circuit. Each selection module is connected to a master scan control line and a plurality of local gate scan lines. One of the selection modules acquires the scan and the enable signals, selects a target gate scan line from the local gate scan lines connected to the selection module, and outputs the scan signal.

### CROSS-REFERENCE TO RELATED APPLICATION

This application claims the benefit of Taiwan Patent Application No. 099111981, filed on Apr. 16, 2010, which is hereby incorporated by reference for all purposes as if fully set forth herein.

### BACKGROUND OF THE INVENTION

1. Field of Invention

The present invention relates to a scan drive control system and method for a liquid crystal panel and a computer program product thereof, and more particularly to a scan drive control system and method for a liquid crystal panel that integrates a selection circuit to reduce a wiring area and a computer program product thereof.

2. Related Art

FIG. 1 is a schematic view of substrate wiring of a liquid crystal panel in the prior art. In the prior art, the liquid crystal panel includes an effective display area 12, a control circuit 11, and a time controller (T-Con) 10. The effective display area 12 is formed by arranging a plurality of pixel circuits 13, which includes a plurality of gate scan lines (G1 to Gn) and source data lines (S1 to Sn), for transmitting scan signals. The control circuit 11 is usually formed of a gate integrated circuit (IC) and a source IC electrically connected to the gate scan lines (G1 to Gn) and the source data lines (S1 to Sn) individually.

The T-Con 10 is used for generating a scan signal periodically. The scan signal is received by the control circuit 11 periodically. The control circuit 11 outputs the scan signals in sequence according to a sequence of the gate scan lines (G1 to Gn), so as to enable each pixel circuit 13 of the liquid crystal panel to update a frame displayed in its effective display area 12 according to frame data output by the source data lines (S1 to Sn).

However, as the TFT-LCD technology is becoming mature day by day, the demands for liquid crystal panel products are increased and the attention of demand for the space of the layout design for panel is also raised accordingly. Referring to FIG. 1 together with FIG. 2, FIG. 2 is a schematic view of a configuration number of scan lines in the prior art. It is assumed that the number of gate scan lines is n, a width of a desired wiring area is W, and the number of wires connected to the gate scan lines (G1 to Gn) from the control circuit 11 is also n. If a resolution of a screen of a product becomes higher, the number of the gate scan line is definitely increased, the number of desired wires is also increased, and the width W of the wiring area is definitely increased accordingly.

Therefore, the width of the liquid crystal panel is unable to be decreased effectively, which does not conform to a design trend of a panel currently, that is, principles of light in weight, compact in size, and narrow width in border designs for a panel.

### SUMMARY OF THE INVENTION

The present invention is directed to a scan signal control system and method for a liquid crystal panel, which is able to reduce the number of scan lines and provide a higher frame resolution.

In order to solve the above-mentioned problem, the present invention provides a scan drive control system for a liquid crystal panel, used for controlling a plurality of gate scan lines of the liquid crystal panel, comprising a time controller, a gate integrated circuit (IC), and a plurality of selection modules.

The time controller is used for generating at least one scan signal periodically. The gate IC comprises a plurality of master scan control lines and at least one enable circuit, and the gate integrated circuit is used for acquiring the scan signal periodically, so as to output the scan signal in sequence through the master scan control lines according to a signal transmission sequence of the master scan control lines, and output an enable signal corresponding to the scan signal and an occurred period of the scan signal through the enable circuit.

The selection modules connected to the master scan control lines of the gate IC which outputting the scan signal acquire the enable signal and the scan signal. Each of the selection modules is connected to a master scan control line and a plurality of local gate scan lines, and the selection modules select a target gate scan line from the local gate scan lines and output the scan signal.

In order to solve the above-mentioned problem, the present invention provides a scan drive control method for a liquid crystal panel, used for controlling a plurality of gate scan lines of a liquid crystal panel, comprising: generating at least one scan signal periodically by a time controller, acquiring the scan signal periodically by a gate integrated circuit (IC) so as to generate an enable signal corresponding to the scan signal and an occurred period of the scan signal, outputting the scan signal and the enable signal to a plurality of selection modules in sequence by the gate IC according to a signal output sequence of a plurality of master scan control lines of the gate IC, and selecting a target gate scan line among a plurality of local gate scan lines connected to the selection module by any of the selection modules that acquires the enable signal and the at least one scan signal, so as to output the scan signal through the target gate scan line.

The present invention further provides a computer program product, arranged in a gate integrated circuit (IC) of a liquid crystal panel. When a gate IC reads the computer program product, a scan drive control method for a liquid crystal panel is performed, and the method comprising: acquiring at least one scan signal generated by a time controller periodically, by the gate IC, so as to generate an enable signal corresponding to the scan signal and an occurred period of the scan signal, outputting the scan signal and the enable signal by the gate IC to a plurality of selection modules in sequence according to a sequence of a plurality of master scan control lines of the gate IC, and selecting a target gate scan line among a plurality of local gate scan lines connected to the selection module by any of the selection modules that acquires the enable signal and the at least one scan signal, so as to output the scan signal through the target gate scan line.

For the present invention, a selection module is arranged between a gate integrated circuit (IC) and gate scan lines, so that a wiring number of scan control lines of the gate IC is reduced, thereby decreasing practically needed wiring space, and at the same time a dimension of the panel is decreased, such that the panel can also be light in weight, compact in size and highly portable. Moreover, in the present invention, pixel circuits in an effective display area of the panel do not need to be changed and re-designed, the design of the pixel circuits is also not influenced, and a pixel aperture ratio is not impaired, and at the same time the present invention is applicable to various existing mask processes, so that the implementation and compatibility are enhanced.

### BRIEF DESCRIPTION OF THE DRAWINGS

The present invention will become more fully understood from the detailed description given herein below for illustration only, and thus are not limitative of the present invention, and wherein:

FIG. 1 is a schematic view of wiring of a substrate of a liquid crystal panel in the prior art;

FIG. 2 is a schematic view of a configuration number of scan lines in the prior art;

FIG. 3 is a schematic system structural view of a scan drive control system for a liquid crystal panel according to the present invention;

FIG. 4A is a circuit diagram of a scan drive control system for a liquid crystal panel using a one-to-two selection circuit according to the present invention;

FIGS. 4B to 4I are schematic views of transmission of scan signals of a scan drive control system for a liquid crystal panel according to the present invention;

FIG. 5 is a schematic view of signal changes in a scan drive control system for a liquid crystal panel according to an embodiment of the present invention;

FIG. 6 is a schematic view of the number of scan line wiring in a scan drive control system for a liquid crystal panel according to the present invention;

FIG. 7 shows a scan drive control method for a liquid crystal panel according to the present invention; and

FIG. 8 is a schematic view of an operation process of a computer program product according to the present invention.

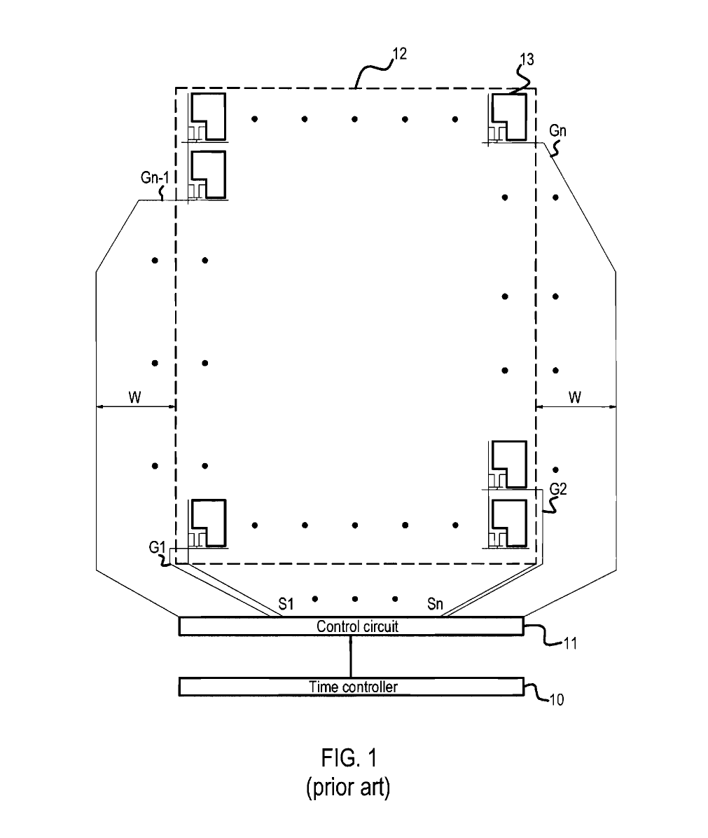

### DETAILED DESCRIPTION OF THE INVENTION

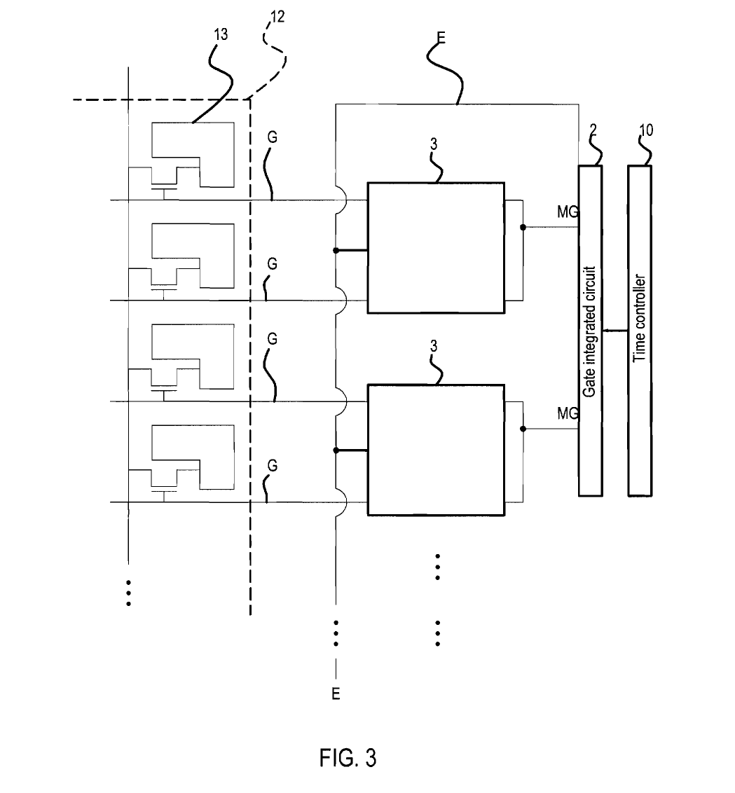

The preferred embodiments of the present invention are illustrated in detail below with reference to the accompanying drawings. FIG. 3 is a schematic system structural view of a scan drive control system for a liquid crystal panel according to the present invention. The system of this embodiment includes a time controller (T-Con) 10, a gate integrated circuit (IC), and a plurality of selection modules 3. The system is applied to a liquid crystal panel having an effective display area 12. A plurality of pixel circuits 13 are arranged in this effective display area 12, and a plurality of gate scan lines G is connected to the pixel circuits 13.

The T-Con 10 is electrically connected to the gate IC 2. The gate IC 2 includes a plurality of master scan control lines MG and at least one enable circuit E. Each selection module 3 is a one-to-many selection circuit, for example, a one-to-two selection circuit, a one-to-three selection circuit, and a one-to-four selection circuit. However, the present invention is not limited thereto. Each selection module 3 is connected to a master scan control line MG individually and connected to a plurality of local gate scan lines (a part of circuitry among all the gate scan lines G, which is illustrated below). However, all the selection modules 3 are connected to the enable circuit E.

The T-Con 10 is used for generating at least one scan signal periodically. The gate IC 2 receives the scan signal and acquires a work period of the scan signal accordingly to generate at least one enable signal corresponding to the scan signal and the occurred period of the scan signal. The gate IC 2 outputs the scan signal from each master scan control line MG in sequence according to a signal output sequence of the master scan control lines MG corresponding to the scan signal, and outputs the enable signal corresponding to the scan signal through the enable circuit E when the scan signal is output.

One among all the selection modules 3 acquires the enable signal and the scan signal at the same time, which is regarded as a working selection module here. The working selection module selects a target gate scan line from the local gate scan lines connected thereto according to the enable signal and the scan signal, and outputs the scan signal from the target gate scan line.

The gate IC 2 controls the number of times that the scan signal is output from the master scan control lines MG in each work period, which is equal to the number of local gate scan lines connected to the selection module 3 that acquires the scan signal. For example, when a selection module 3 is a one-to-two selection circuit, the number of times that the gate IC 2 transmits the scan signal to the selection module 3 periodically is a multiple of 2, and the gate IC 2 transmits the enable signal at a number of times corresponding to that of the scan signal. The selection module 3 outputs acquired scan signals in sequence from different local gate scan lines according to the enable signal and the scan signal.

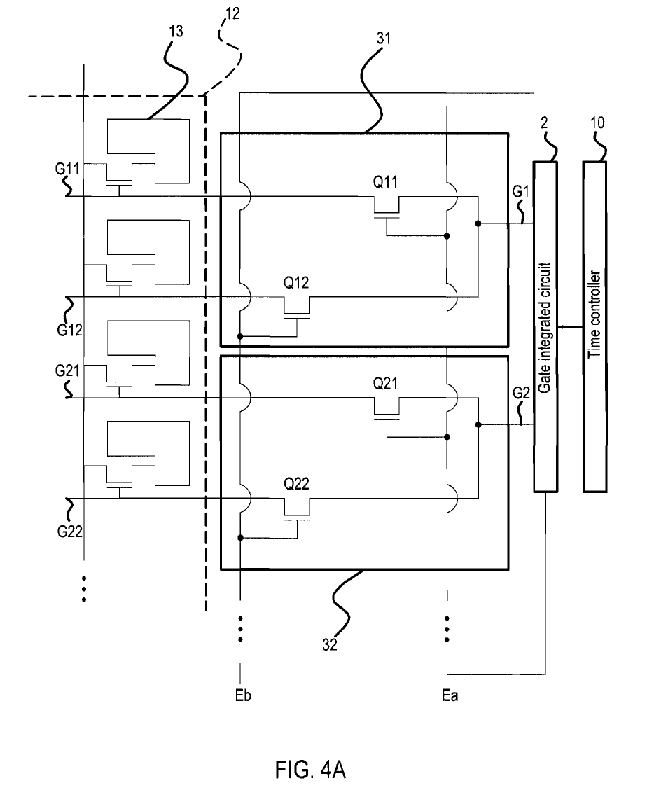

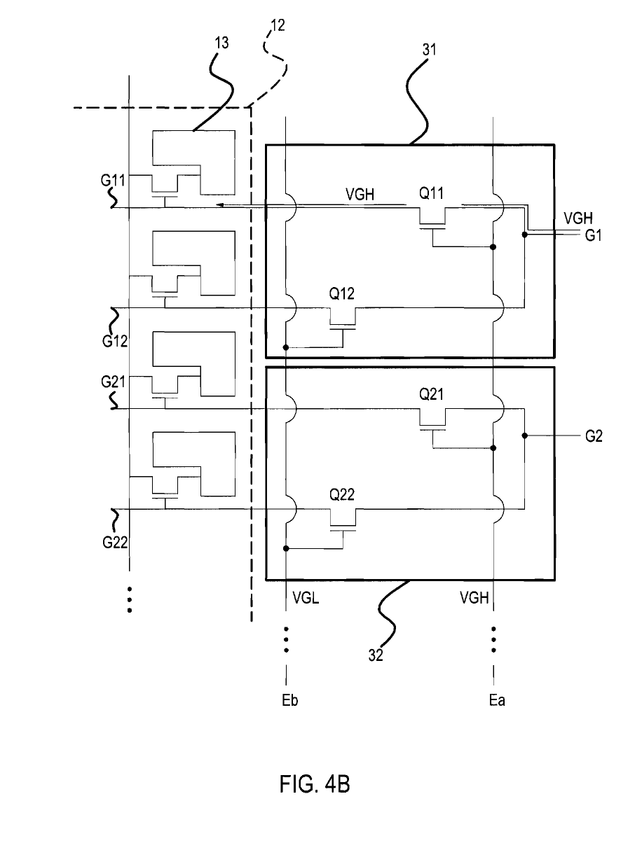

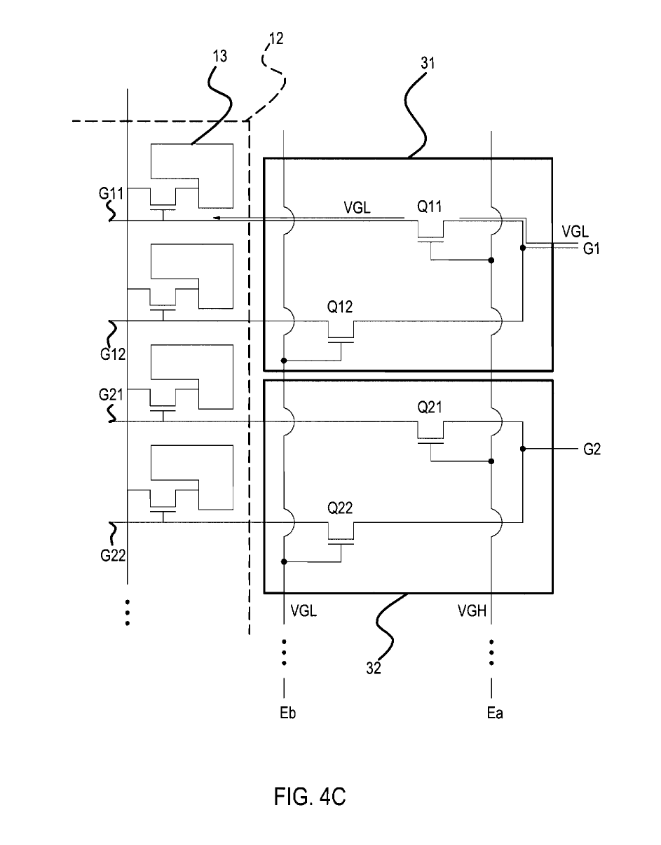

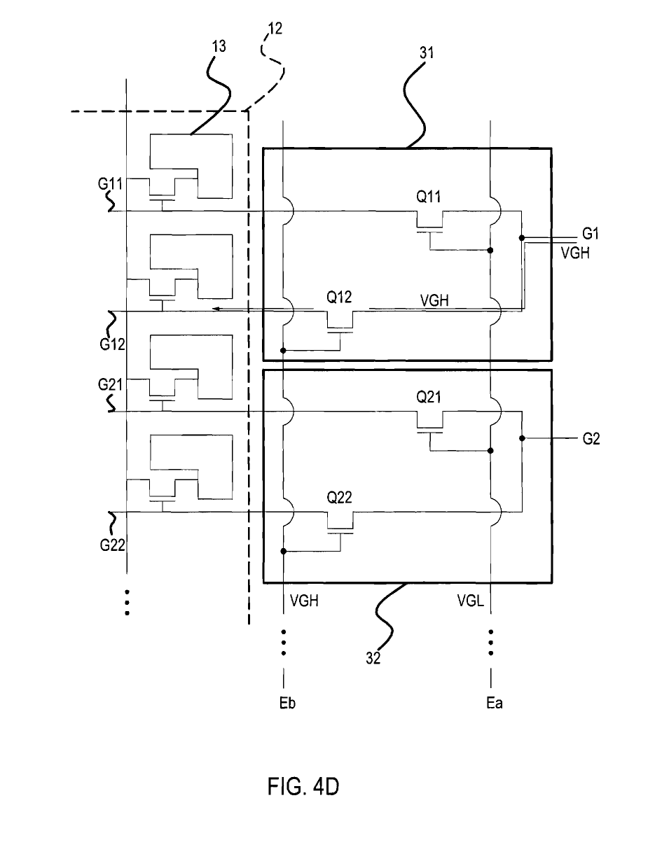

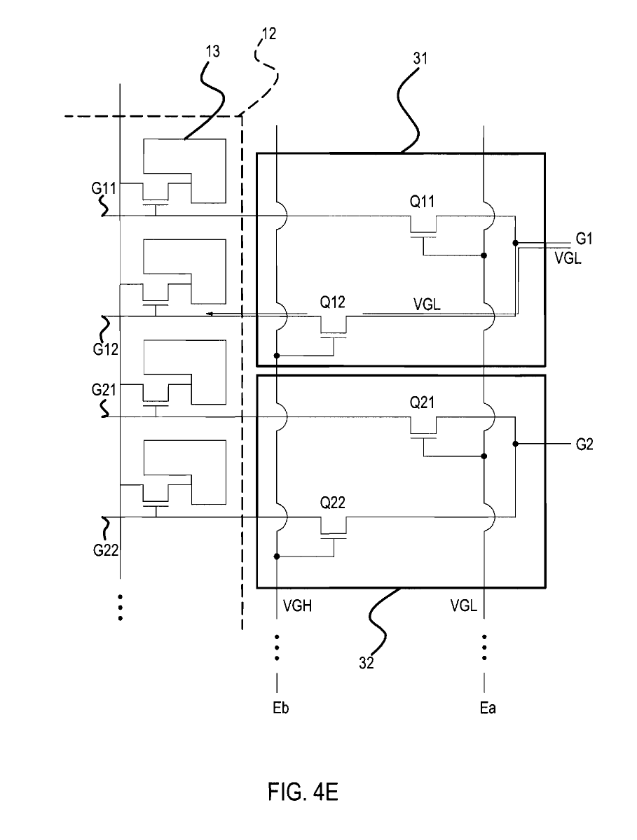

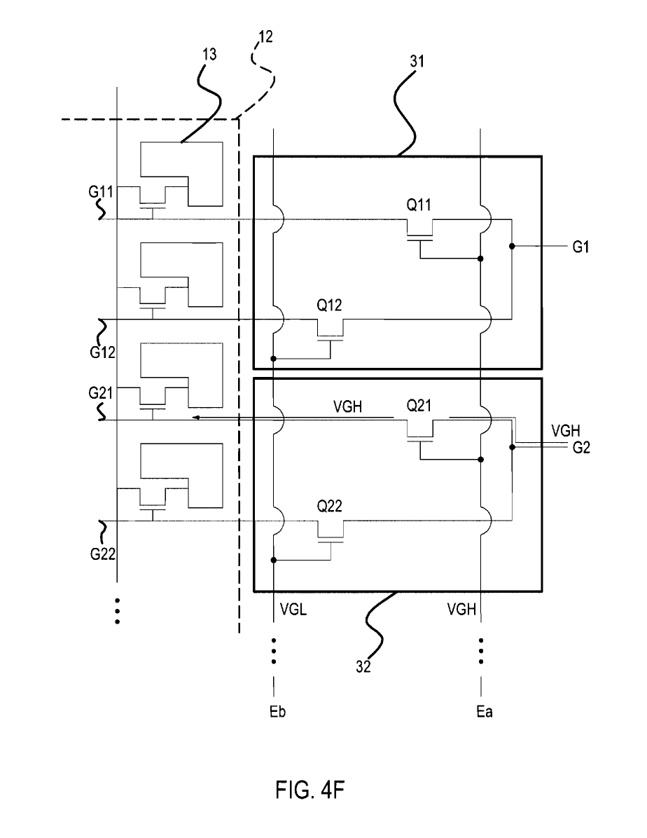

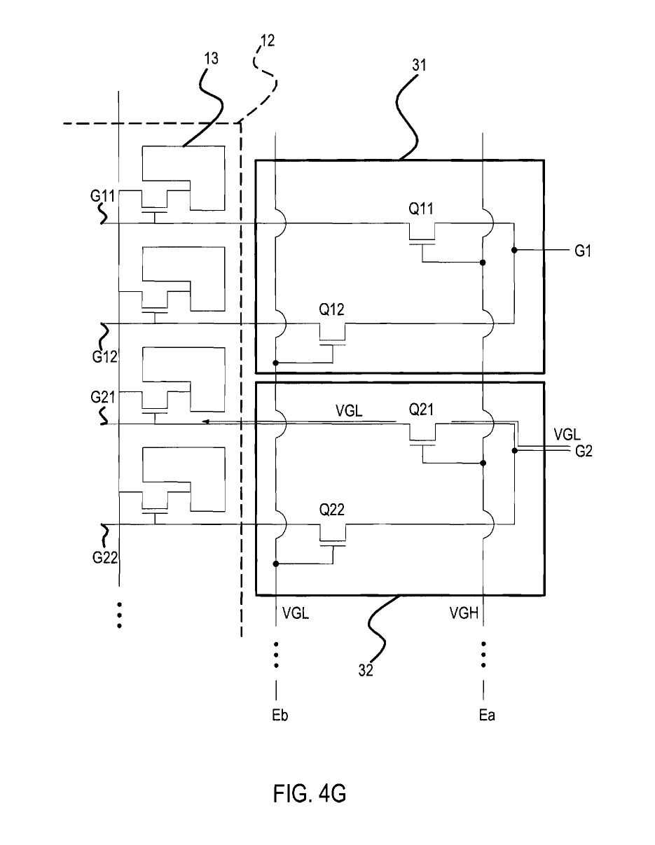

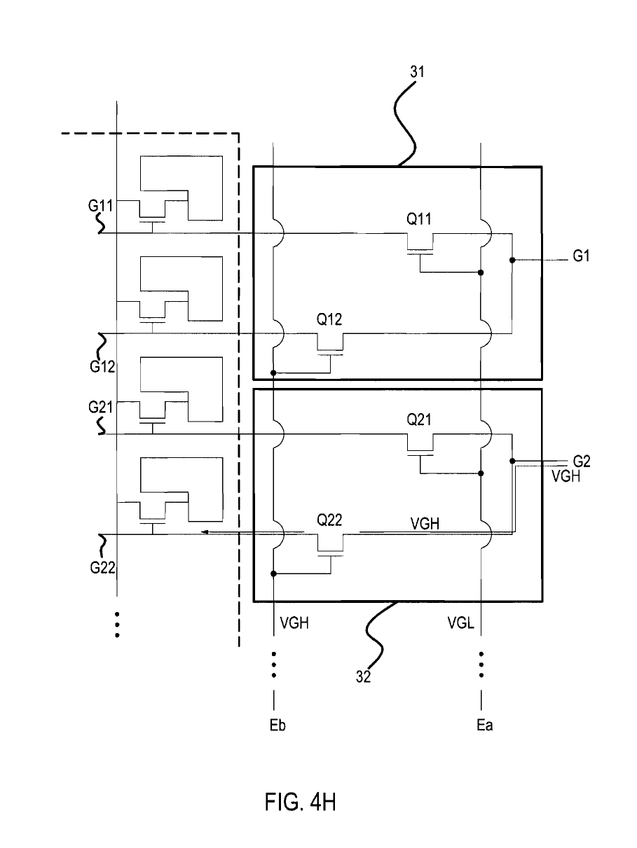

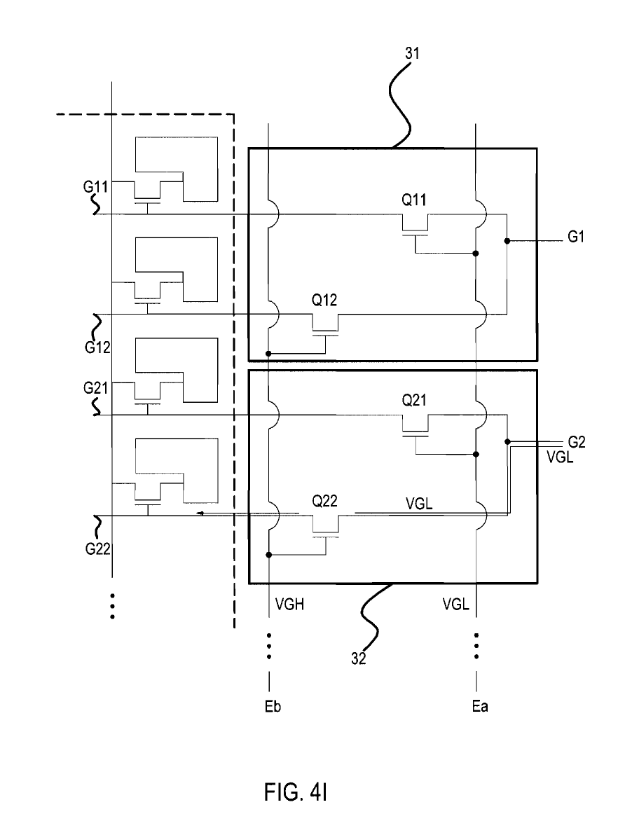

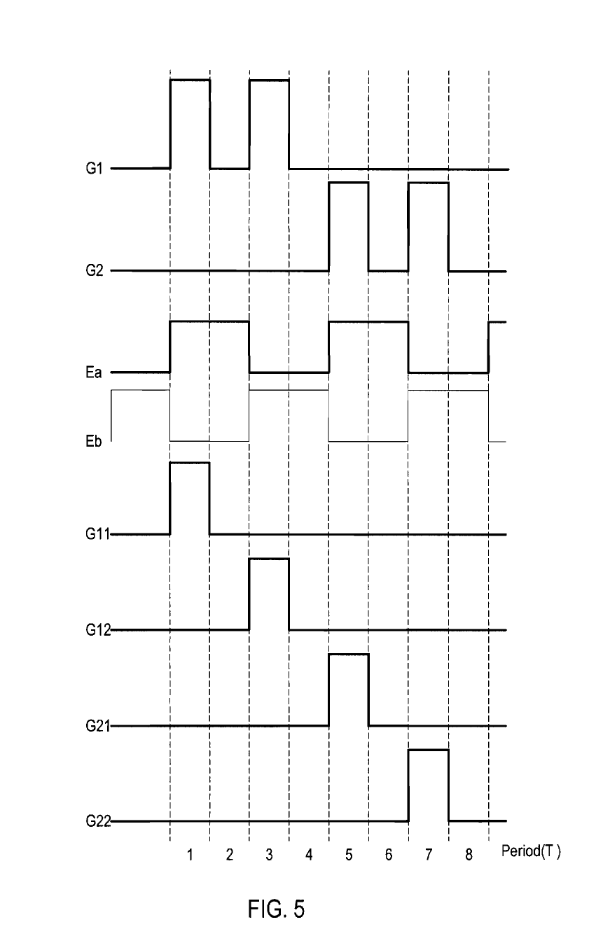

FIG. 4A is a circuit diagram of a scan drive control system for a liquid crystal panel using a one-to-two selection circuit according to the present invention. FIGS. 4B to 4I are schematic views of scan signal transmission of a scan drive control system for a liquid crystal panel according to the present invention. FIG. 5 is a schematic view of signal changes in a scan drive control system for a liquid crystal panel according to an embodiment of the present invention. As shown in FIG. 4A, for the system architectural view as shown in FIG. 3, a one-to-two selection circuit is taken as an example for the selection module 3 in this embodiment and the illustration is provided through two master scan control lines (G1 and G2) in combination with four local gate scan lines (G11, G12, G21, and G22). Also, each selection circuit 3 is connected to an enable circuit Ea and an enable circuit Eb of the gate IC individually. As discussed above, the T-Con 10 is used for outputting scan signals periodically, which are received by the gate IC 2.

As shown in FIGS. 5 and 4B, the gate IC 2 acquires a scan signal in a first work period which is forwarded through the master scan control line G1 and at the same time an enable signal corresponding to the scan signal is output from the enable circuit Ea and the enable circuit Eb. The first selection circuit 31 acquires the enable signal and the scan signal, and selects one of the local gate scan line G11 and the local gate scan line G12 to output the scan signal according to data content (or a voltage value) of each signal. As shown in FIGS. 5 and 4B, in the first period, each signal is denoted by a symbol. When G1=VGH (at a high potential), Ea=VGH (the enable signal transmitted by the enable circuit Ea is at a high potential), and Eb=VGL (the enable signal transmitted by the enable circuit Eb is at a low potential), Q11=ON (a transistor Q11 is on) and G11=VGH (at a high potential), that is, G11 acquires the scan signal VGH.

As shown in FIGS. 5 and 4C, the gate IC 2 acquires a scan signal in a second work period which is forwarded from the master scan control line G1 and at the same time an enable signal corresponding to the scan signal is output from the enable circuit Ea and the enable circuit Eb. The first selection circuit 31 acquires the enable signal and the scan signal, and selects one of the local gate scan line G11 and the local gate scan line G12 to output the scan signal according to data content (or a voltage value) of each signal. As shown in FIGS. 5 and 4C, in the second period, each signal is denoted by a symbol. When G1=VGL (at a low potential), Ea=VGH (the enable signal transmitted by the enable circuit Ea is at a high potential), and Eb=VGL (the enable signal transmitted by the enable circuit Eb is at a low potential), Q11=ON (the transistor Q11 is on) and G11=VGL (at a low potential), that is, G11 acquires the scan signal VGL.

As shown in FIGS. 5 and 4D, the gate IC 2 acquires a scan signal in a third work period which is forwarded through the master scan control line G1 and at the same time an enable signal corresponding to the scan signal is output from the enable circuit Ea and the enable circuit Eb. The first selection circuit 31 acquires the enable signal and the scan signal, and selects one of the local gate scan line G11 and the local gate scan line G12 to output the scan signal according to data content (or a voltage value) of each signal. As shown in FIGS. 5 and 4D, in the third period, each signal is denoted by a symbol. When G1=VGH (at a high potential), Ea=VGL (the enable signal transmitted by the enable circuit Ea is at a low potential), and Eb=VGH (the enable signal transmitted by the enable circuit Eb is at a high potential), Q12=ON (the transistor Q12 is on) and G12=VGH (at a high potential), that is, the G12 acquires the scan signal VGH.

As shown in FIGS. 5 and 4E, the gate IC 2 acquires a scan signal in a fourth work period which is forwarded through the master scan control line G1 and at the same time an enable signal corresponding to the scan signal is output from the enable circuit Ea and the enable circuit Eb. The first selection circuit 31 acquires the enable signal and the scan signal, and selects one of the local gate scan line G11 and the local gate scan line G12 to output the scan signal according to data content (or a voltage value) of each signal. As shown in FIGS. 5 and 4E, in the fourth period, each signal is denoted by a symbol. When G1=VGL (at a low potential), Ea=VGL (the enable signal transmitted by the enable circuit Ea is at a low potential), and Eb=VGH (the enable signal transmitted by the enable circuit Eb is at a high potential), Q12=ON (the transistor Q12 is on) and G12=VGL (at a low potential), that is, G12 acquires the scan signal VGL.

Similarly, as shown in FIGS. 5 and 4F, the gate IC 2 acquires a scan signal in a fifth work period which is forwarded through the master scan control line G2 and at the same time an enable signal corresponding to the scan signal is output through the enable circuit Ea and the enable circuit Eb. The second selection circuit 32 acquires the enable signal and the scan signal, and selects one of the local gate scan line G21 and the local gate scan line G22 to output the scan signal according to data content (or a voltage value) of each signal. As shown in FIGS. 5 and 4F, in the fifth period, each signal is denoted by a symbol. When G2=VGH (at a high potential), Ea=VGH (the enable signal transmitted by the enable circuit Ea is at a high potential), and Eb=VGL (the enable signal transmitted by the enable circuit Eb is at a low potential), Q21=ON (the transistor Q21 is on) and G21=VGH (at a high potential), that is, G21 acquires the scan signal VGH.

As shown in FIGS. 5 and 4G, the gate IC 2 acquires a scan signal in a sixth work period which is forwarded through the master scan control line G2 and at the same time an enable signal corresponding to the scan signal is output through the enable circuit Ea and the enable circuit Eb. The second selection circuit 32 acquires the enable signal and the scan signal, and selects one of the local gate scan line G21 and the local gate scan line G22 to output the scan signal according to data content (or a voltage value) of each signal. As shown in FIGS. 5 and 4G, in the sixth period, each signal is denoted by a symbol. When G2=VGL (at a low potential), Ea=VGH (the enable signal transmitted by the enable circuit Ea is at a high potential), and Eb=VGL (the enable signal transmitted by the enable circuit Eb is at a low potential), Q21=ON (the transistor Q21 is on) and G21=VGL (at a low potential), that is, the G21 acquire the scan signal VGL.

As shown in FIGS. 5 and 4H, the gate IC 2 acquires a scan signal in a seventh work period which is forwarded through the master scan control line G2 and at the same time an enable signal corresponding to the scan signal is output from the enable circuit Ea and the enable circuit Eb. The second selection circuit 32 acquires the enable signal and the scan signal, and selects one of the local gate scan line G21 and the local gate scan line G22 to output the scan signal according to data content (or a voltage value) of each signal. As shown in FIGS. 5 and 4H, in the seventh period, each signal is denoted by a symbol. When G2=VGH (at a high potential), Ea=VGL (the enable signal transmitted by the enable circuit Ea is at a low potential), and Eb=VGH (the enable signal transmitted by the enable circuit Eb is at a high potential), Q22=ON (the transistor Q22 is on) and G22=VGH (at a high potential), that is, the G22 acquires the scan signal VGH.

As shown in FIGS. 5 and 4I, the gate IC 2 acquires a scan signal in an eighth work period which is forwarded from the master scan control line G2 and at the same time an enable signal corresponding to the scan signal is output through the enable circuit Ea and the enable circuit Eb. The second selection circuit 32 acquires the enable signal and the scan signal, and selects one of the local gate scan line G21 and the local gate scan line G22 to output the scan signal according to data content (or a voltage value) of each signal. As shown in FIGS. 5 and 4I, in the eighth period, each signal is denoted by a symbol.

When G2=VGL (at a low potential), Ea=VGL (the enable signal transmitted by the enable circuit Ea is at a low potential), and Eb=VGH (the enable signal transmitted by the enable circuit Eb is at a high potential), Q22=ON (the transistor Q22 is on) and G22=VGL (at a low potential), that is, the G22 acquires the scan signal VGL.

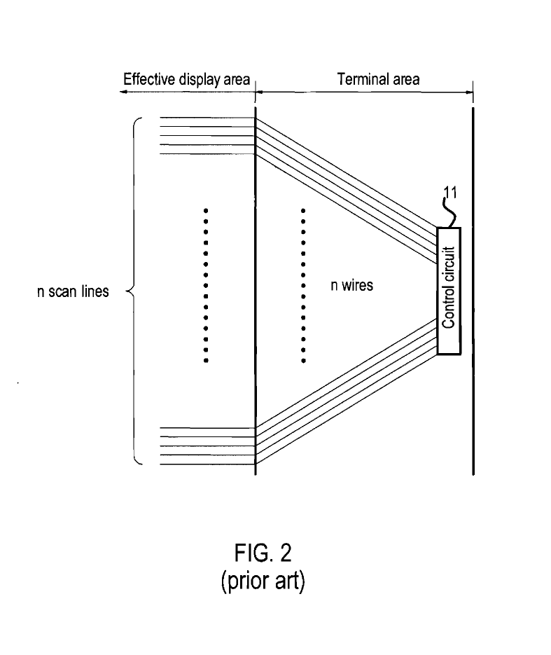

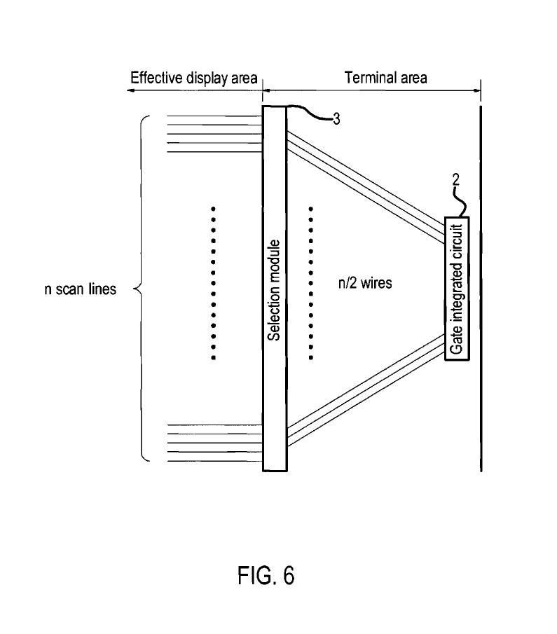

FIG. 6 is a schematic view of the wiring number of scan lines in a scan drive control system for a liquid crystal panel according to the present invention. Referring to FIG. 2 at the same time for ease of understanding, as shown in FIGS. 6 and 2, when the number of gate scan lines are the same and the system uses the one-to-two selection module, during wiring of the master scan control lines for the gate IC 2, the desired wiring number is half of the number in the prior art. Therefore, an arrangement space needed for the selection module 3 is reduced, so that the wiring space can be decreased by nearly a half area of the original wiring space. However, according to different demands of designers, the system is also applicable to other one-to-many selection circuits and the enable circuit E also has different designs according to circuit demands, but the present invention is not limited thereto.

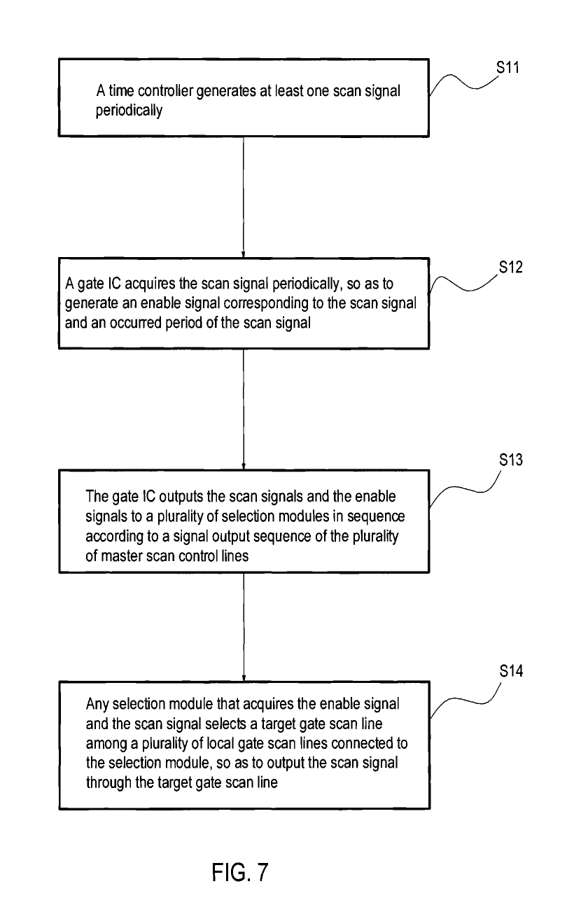

FIG. 7 shows a scan drive control method for a liquid crystal panel according to the present invention. Referring to FIG. 3 at the same time for ease of understanding, the method is used for controlling a plurality of gate scan lines of the liquid crystal panel. The method includes the following steps.

A T-Con generates at least one scan signal periodically (Step S11). As shown in FIG. 3, a liquid crystal panel has an effective display area 12. A plurality of pixel circuits 13 is arranged in this effective display area 12. A plurality of gate scan lines G is connected to all pixel circuits 13. The T-Con10 is electrically connected to the gate IC 2 and generates at least one scan signal periodically. A gate IC acquires the scan signal periodically, so as to generate an enable signal corresponding to the scan signal and an occurred period of the scan signal (Step S12).

The gate IC 2 includes a plurality of master scan control lines MG and at least one enable circuit E. The gate IC 2 receives the scan signal and acquires a work period of the scan signal accordingly to generate at least one enable signal corresponding to the scan signal and an occurred period of the scan signal.

The gate IC outputs the scan signals and the enable signals to a plurality of selection modules in sequence according to a signal output sequence of the plurality of master scan control lines (Step S13). The gate IC 2 outputs the scan signals from all master scan control lines MG in sequence according to a signal output sequence of the master scan control lines MG corresponding to the scan signals. When the scan signals are output, the enable signals corresponding to the scan signals are output through the enable circuit E.

Any selection module that acquires the enable signal and the scan signal selects a target gate scan line among a plurality of local gate scan lines connected to the selection module, so as to output the scan signal through the target gate scan line (Step S14). Each selection module 3 is a one-to-many selection circuit, for example, a one-to-two selection circuit, a one-to-three selection circuit, and a one-to-four selection circuit, but the present invention is not limited thereto. Each selection module 3 is connected to a master scan control line MG individually and connected to a plurality of local gate scan lines (for example, the G11, G12, G21, and G22). However, all the selection modules 3 are connected to the enable circuit E. One of the selection modules 3 acquires the enable signal and the scan signal at the same time, and is regarded as a working selection module here. The working selection module selects one target gate scan line among the local gate scan lines connected to the working selection module according to the enable signal and the scan signal, so as to output the scan signal from the target gate scan line.

The gate IC 2 controls the number of times that scan signals of related master scan control lines MG are output in each work period, which is equal to the number of local gate scan lines that the selection module 3 acquiring the scan signals is connected to. For example, when a selection module 3 is a one-to-two selection circuit, the number of times that the gate IC 2 transmits the scan signals to the selection module periodically is a multiple of 2, and the gate IC 2 transmits enable signals in a different number of times. The selection module 3 outputs the scan signal acquired each time in sequence from different local gate scan lines according to the enable signal.

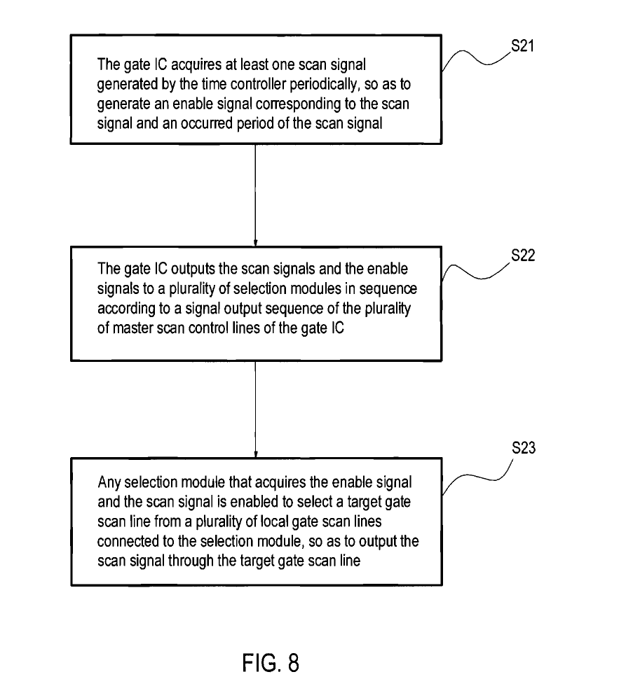

FIG. 8 is a schematic view of an operation process of a computer program product according to the present invention. Referring to FIG. 3 at the same time for ease of understanding, the computer program product is arranged in a gate IC 2 of the liquid crystal panel. When the gate IC 2 reads the computer program product, a scan drive control method for a liquid crystal panel is performed. The operation mode is described as follows.

The gate IC acquires at least one scan signal generated by the T-Con periodically, so as to generate an enable signal corresponding to the scan signal and an occurred period of the scan signal (Step S21).

The T-Con 10 is electrically connected to the gate IC 2. The gate IC 2 includes a plurality of master scan control lines MG and at least one enable circuit E. The T-Con 10 is used for generating at least one scan signal periodically. The gate IC 2 receives the scan signal, and acquires the work period of the scan signal accordingly to generate at least one enable signal corresponding to the scan signal and an occurred period of the scan signal.

The gate IC outputs the scan signals and the enable signals to a plurality of selection modules in sequence according to a signal output sequence of the plurality of master scan control lines of the gate IC (Step S22).

The gate IC 2 outputs the scan signals from the master scan control lines MG in sequence according to the signal output sequence of the master scan control lines MG corresponding to the scan signals, and outputs the enable signals corresponding to the scan signals through the enable circuit E when the scan signals are output.

Any selection module that acquires the enable signal and the scan signal is enabled to select a target gate scan line from a plurality of local gate scan lines connected to the selection module, so as to output the scan signal through the target gate scan line (Step S23). Each selection module 3 is connected to the master scan control line MG and connected to a plurality of local gate scan lines (for example, the first selection circuit 31 is connected to the local gate scan line G11 and the local gate scan line G12, and the second selection circuit 32 is connected to the local gate scan line G21 and the local gate scan line G22). However, the selection modules 3 are all connected to the enable circuit E.

One of all the selection modules 3 acquires the enable signal and the scan signal at the same time, which is regarded as a working selection module here. The working selection module selects a target gate scan line from the local gate scan lines connected to the working selection module according to the enable signal and the scan signal, so as to output the scan signals through the target gate scan lines.

Each of the selection module is a one-to-many selection circuit, for example, a one-to-two selection circuit, a one-to-three selection circuit, and a one-to-four selection circuit, but the present invention is not limited thereto.

In conclusion, the present invention is merely recorded as implementations and embodiments that present the technical measures for solving the problems, but not intended to limit the scope of the patent implementation of the present invention. That is, all equivalent changes and modifications that conform to the meanings of the claims of the present invention or made according to the patent scope of the present invention fall within the patent scope of the present invention.

What is claimed is:

1. A scan drive control system for a liquid crystal panel, used for controlling a plurality of gate scan lines of the liquid crystal panel, comprising:
a time controller, used for generating at least one scan signal periodically;
a gate integrated circuit (IC), comprising a plurality of master scan control lines and at least one enable circuit, used for acquiring the at least one scan signal periodically, outputting the at least one scan signal in sequence through the master scan control lines according to a signal transmission sequence of the master scan control lines, and outputting an enable signal corresponding to the at least one scan signal and an occurred period of the scan signal through the at least one enable circuit; and
a plurality of selection modules, respectively connected to the master scan control lines and at same time connected to the at least one enable circuit, wherein each of the selection modules is connected to a plurality of local gate scan lines, and is used for selecting a target gate scan line from the local gate scan lines and outputting the at least one scan signal when the selection module acquires the at least one scan signal and the enable signal.

2. The scan drive control system for a liquid crystal panel according to claim 1, wherein the selection modules comprise a one-to-many selection circuit.

3. The scan drive control system for a liquid crystal panel according to claim 2, wherein the selection modules comprise a one-to-two selection circuit.

4. The scanning drive/control system for a liquid crystal panel according to claim 2, wherein the selection modules comprise a one-to-three selection circuit.

5. The scan drive control system for a liquid crystal panel according to claim 2, wherein the selection modules comprise a one-to-four selection circuit.

6. The scan drive control system for a liquid crystal panel according to claim 1, wherein a number of times that each of the selection modules acquires the at least one scan signal is equal to a number of the local gate scan lines connected to the selection module, and the selection module that acquires the at least one scan signal selects the target gate scan line according to the at least one enable signal and outputs the at least one scan signal.

7. A scan drive control method for a liquid crystal panel, used for controlling a plurality of gate scan lines of a liquid crystal panel, comprising:
generating, by a time controller, at least one scan signal periodically;
acquiring, by a gate integrated circuit (IC), the at least one scan signal periodically, so as to generate an enable signal corresponding to the at least one scan signal and an occurred period of the scan signal;
outputting, by the gate IC, the at least one scan signal and the enable signal to a plurality of selection modules in sequence according to a signal output sequence of a plurality of master scan control lines of the gate IC; and
selecting, by any of the selection modules that acquires the enable signal and the at least one scan signal, a target gate scan line among a plurality of local gate scan lines connected to the selection module, so as to output the at least one scan signal through the target gate scan line.

8. The liquid crystal panel scan drive control method according to claim 7, wherein each of the selection modules is a one-to-many selection circuit.

9. The scan drive control method for a liquid crystal panel according to claim 8, wherein the selection modules comprise a one-to-two selection circuit.

10. The scan drive control method for a liquid crystal panel according to claim 8, wherein the selection modules comprise a one-to-three selection circuit.

11. The scan drive control method for a liquid crystal panel according to claim 8, wherein the selection modules comprise a one-to-four selection circuit.

12. The scan drive control method for a liquid crystal panel according to claim 7, wherein a number of times that each of the selection modules acquires the at least one scan signal is equal to a number of the local gate scan lines connected to the selection module, and the selection module that acquires the at least one scan signal selects the target gate scan line according to the at least one enable signal and outputs the at least one scan signal.

13. A computer program product, arranged in a gate integrated circuit (IC) of a liquid crystal panel, wherein a scan drive control method for a liquid crystal panel is performed when the gate IC reads the computer program product, and the method comprises:
acquiring, by the gate IC, at least one scan signal generated by a time controller periodically, so as to generate an enable signal corresponding to the at least one scan signal and an occurred period of the scan signal;
outputting, by the gate IC, the at least one scan signal and the enable signal to a plurality of selection modules in sequence according to a sequence of a plurality of master scan control lines of the gate IC; and
selecting, by any of the selection modules that acquires the enable signal and the at least one scan signal, a target gate scan line among a plurality of local gate scan lines connected to the selection module, so as to output the at least one scan signal through the target gate scan line.

14. The computer program product according to claim 13, wherein a number of times that each of the selection modules acquires the at least one scan signal is equal to a number of the local gate scan lines connected to the selection module, and the selection module that acquires the at least one scan signal selects the target gate scan line according to the at least one enable signal and outputs the at least one scan signal.
